(19) United States
(12) Patent Application Publication
(10) Pub. No.: US 2025/0135554 A1
(43) Pub. Date: May 1, 2025

(54) Sensor arrangement for an apparatus for additive manufacturing, apparatus for additive manufacturing and test method

(71) Applicant: EOS GMBH ELECTRO OPTICAL SYSTEMS, Krailling (DE)

(72) Inventors: Florian Bayer, Unterhaching (DE); Sjoerd Fruijtier, München (DE); Peter Steinberg, Pflach (AT); Alois Lohr, Bad Aibling (DE)

(21) Appl. No.: 18/690,682

(22) PCT Filed: Sep. 13, 2022
(86) PCT No.: PCT/EP2022/075442

§ 371 Date: Mar. 8, 2024

(30) Foreign Application Priority Data
Sep. 21, 2021 (DE) 10 2021 124 442.0

(51) Int. Cl. B22F 12/90; B22F 10/32; B33Y 50/00; G01N 27/407

(52) U.S. Cl. CPC B22F 12/90; B22F 10/32; G01N 27/407; B33Y 50/00

(57) ABSTRACT

The invention concerns a sensor arrangement (9) for an apparatus (1) for the additive manufacture of a component (2) in a manufacturing process in which build material (13), preferably comprising a metal powder, is consolidated on a construction area (8) in a processing area (3) by means of irradiation of the build material (13) with at least one energy beam (AL), the sensor arrangement (9) comprising:
a sensor module (90) which is configured to detect oxygen molecules in a gas sample (P) permeating into the sensor module (90) and to generate an electrical sensor signal (S) based on the quantity of the oxygen molecules,
a selective filter element (F) configured to filter the gas sample (P) so that at least hydrogen molecules and/or hydrogen ions and/or water molecules and/or hydroxide ions are filtered out of the gas sample (P).

The invention further concerns a manufacturing apparatus as well as a measurement method with such a sensor arrangement.

The invention relates to a sensor arrangement for an apparatus for the additive manufacture of a component in a manufacturing process in which build material, preferably comprising a metal powder, is consolidated layer by layer on a construction area in a processing area by means of irradiation of the build material with at least one energy beam, as well as to an apparatus of this type and a measurement method with a sensor arrangement of this type.

Additive manufacturing processes are becoming more and more relevant to the production of prototypes and recently also in mass production. In general, the term “additive manufacturing processes” should be understood to mean those manufacturing processes in which, generally on the basis of digital 3D construction data, a manufactured product (also referred to below as a “component”) is constructed by depositing material (the “build material”). The construction is usually layer by layer, but not necessarily so. A synonym for additive manufacture which is also often employed is the term “3D printing”; the production of models, samples and prototypes with additive manufacturing processes is often termed “rapid prototyping”; the production of tools is often termed “rapid tooling” and the flexible production of mass produced components is often termed “rapid manufacturing”. As mentioned above, a central point is the selective consolidation of the build material, wherein in many manufacturing processes, this consolidation may be carried out with the aid of an irradiation with radiant energy, for example electromagnetic radiation, in particular light radiation and/or thermal radiation, but if appropriate also with particle beams such as electron beams, for example. Examples of processes operating by irradiation are “selective laser sintering” or “selective laser melting”. In this regard, thin layers of a mainly powdered build material are repetitively applied one on top of the other. In each layer, the build material is selectively consolidated by spatially limited irradiation of the points which are intended to belong to the component to be produced after manufacture, in a “welding process” in which the grains of powder of the build material are partially or completely melted with the aid of the localized energy introduced at this point by the radiation. After cooling, these grains of powder are then consolidated together to form a solid body. In this regard, usually, the energy beam is guided along consolidation tracks over the construction area and the melting or consolidation of the material correspondingly occurs in the respective layer in the form of “weld tracks” or “weld beads” so that finally, a plurality of layers formed from such weld tracks are present in the component. Components with a very high quality and breaking strength can now be produced in this manner.

However, it should be noted that the oxygen content in the processing chamber has an influence on the quality of the components. In particular, there is a correlation between the porosity of metallic components and the concentration of oxygen in the processing chamber. For this reason, for highest quality and strength components, the oxygen concentration during the build process in the processing chamber should be measured and should not exceed 1000 ppm, for example.

Even when, in practice, operations are carried out in a protective gas atmosphere in the processing area, as a rule, however, this is always “contaminated” by oxygen. This is particularly due to the fact that oxygen can permeate into the system through leaks. Even when the processing area itself is under a slight over-pressure, there are still points in the overall system, in the lines or the filters, at which an under-pressure may prevail. At these points, oxygen, for example, can permeate into the system and also into the processing chamber because of the movement of gas. However, oxygen can also be generated as moisture (water vapour) in the system. As a rule, the build material contains a certain residual moisture. This gets into the processing area by evaporation. In the region of the energy beam, water molecules can be split into oxygen atoms and hydrogen atoms due to its high energy and power; these then recombine in the form of molecular hydrogen and oxygen. Because of the relatively low concentrations of atomic hydrogen and atomic oxygen which are generated from the laser-induced splitting of water, it is also conceivable that the atomic hydrogen and atomic oxygen might not recombine fully and for this reason, atomic species could also be present in the processing chamber. In particular, atomic hydrogen may have a negative influence on the stability of a measurement of the oxygen concentration, as will be explained below.

The oxygen concentration (from molecular oxygen) in the processing area is measured with an oxygen sensor. In this regard, there are a variety of functional principles. Amperometric sensors and potentiometric sensors may be mentioned here in particular. In potentiometric sensors, a voltage or a resistance reflects the oxygen concentration. In amperometric sensors, oxygen molecules are ionised at a cathode and recombine at an anode, whereupon a current is produced which is proportional to the oxygen concentration.

The measurement of oxygen may, however, be erroneous under specific circumstances; this is in particular due to a cross-sensitivity of the sensor between hydrogen and water molecules. At low oxygen concentrations, these substances can produce erroneous signals in the sensor. These erroneous signals are primarily due to water and hydrogen molecules, which could potentially falsify the signal by various mechanisms or chemical reactions. Both hydrogen as well as water can be adsorbed by the electrodes of the sensor, depending on the material of construction and can each be split there into hydrogen anions and cations and hydroxide ions and hydrogen anions. The adsorbed state of molecular hydrogen and the corresponding splitting into hydrogen anions and cations can have a positive or negative influence on the electrical resistance (and the electrical signal generated therefrom) of the electrodes, depending on the temperature and pressure conditions. The same effect may also occur with the absorption of atomic hydrogen, which may be generated in the processing chamber from the splitting of water, as explained above. Instabilities in the signal can therefore be explained by the adsorption of (molecular or atomic) hydrogen on the electrode surface. Furthermore, the observed instabilities in the signal can also be explained by a chemical weighting between water, hydrogen and oxygen which is generated under the temperature conditions in the environment of the sensor and by the catalytic action of the sensor electrodes in the environment of the sensor.

In particular, the working principle of sensors which are based on the amperometric principle means that the signals behave in an unstable manner due to cross-sensitivity when the oxygen concentration drops to low values of approximately <400 ppm, for example because of an increase in moisture or hydrogen at the sensor. The value of 400 ppm which is given here is not the desired concentration of oxygen in the processing chamber (which is approximately 0.1%), but the limit below which the measurement signal at the sensor typically becomes unstable. In particular, at an oxygen concentration of <400 ppm, a mutual generation of water and hydrogen/oxygen and therefore a severely fluctuating signal characteristic may be produced.

An objective of the present invention is to provide a sensor arrangement or an apparatus which exhibits stable signal behaviour even at low oxygen concentrations, so that an additive manufacture of a component can always take place under defined conditions.

This objective is achieved by means of a sensor arrangement in accordance with patent claim 1, an apparatus in accordance with patent claim 8 and a measurement method in accordance with patent claim 11.

A sensor arrangement in accordance with the invention serves in an apparatus for the additive manufacture of a component in a manufacturing process (“manufacturing apparatus”) in which build material, preferably comprising a metal powder, is consolidated on a construction area in a processing area by means of irradiation of the build material with at least one energy beam. The sensor arrangement comprises the following components:
a sensor module which is configured to detect oxygen molecules in a gas sample permeating into the sensor module and to generate an electrical sensor signal based on the quantity of the oxygen molecules,
a selective filter element configured to filter the gas sample so that at least hydrogen molecules and/or hydrogen ions and/or water molecules and/or hydroxide ions are filtered out of the gas sample.

The two components cited here may be housed acting together on or in a housing or may be separate from each other, wherein in this case, the filter element must be mounted in such a manner that it can filter the gas sample. As an example, the sensor module may be disposed in a gas line and the filter element may be mounted in a manner such that it filters the flow of gas through the gas line. Clearly, the sensor arrangement may comprise other components, for example elements for retaining or mounting the sensor, electronics for processing the measurement signals (for example an ADC), or a controller for controlling the measurement operation.

A suitable sensor module is known in the prior art. The invention may be used in a particularly advantageous manner for amperometric or potentiometric sensors, but is also advantageous for other sensors. The sensor modules may be equipped with a reference sensor and/or a reference component which is capable of carrying out a reference measurement. In particular in the case of potentiometric sensors, a reference chamber or the reference volume is integrated into the sensor, wherein the reference volume is in direct contact with an electrode. The term “reference sensor” as used below should also be understood to mean the “reference component” of a sensor. In the case of amperometric sensors, the reference sensor and/or the reference component is an electrochemical reference cell, for example a solid cell (for example, solid cells produced from palladium, rhodium, rubidium and the corresponding oxides are used for the measurement), and in the case of potentiometric sensors, a reference gas volume is used. A reference sensor and/or a reference component may, however, also be disposed or configured in a manner such that its gas sample is not filtered by the filter element or is filtered through another filter element.

It should be noted that a sensor generates its sensor signal as a function of the oxygen molecules present in the measuring zone. Thus, the sensor signal is first of all dependent on the quantity of oxygen molecules. However, because the measurement parameters are usually known (for example the volume of the gas sample and its pressure), usually, the oxygen concentration can be deduced directly from the sensor signal, or the sensor signal is a direct measure of the oxygen concentration. Preferably, the sensor signal is proportional to the oxygen concentration.

The sensor signal may be an analogue signal, in particular a voltage or a current, or a digital signal, for example a digital numerical value. Finally, an analogue signal may be obtained by conversion using an analogue-to-digital converter (ADC).

The filter element is selective, which means that it does not filter all molecules, but selectively individual molecular species or a group of molecular species. These molecular species are at least hydrogen molecules and/or hydrogen ions and/or water molecules and/or hydroxide ions. These may give rise to interfering signals in the sensor, which could have a disadvantageous effect, in particular at low oxygen concentrations. If these molecular species are now filtered out of the gas sample, the oxygen concentration is only insignificantly modified because the largest fraction of the gas sample is formed by the protective gas or inert gas, for example argon or nitrogen. Thus, interfering fractions in the sensor signal may be reduced without substantially falsifying the predictive power of the sensor signal.

It should be noted here that, in particular in the case of amperometric sensors, water and hydrogen lead to interfering fractions in the sensor signal. As an example, in the case of an amperometric Nernst cell, a voltage is applied to the two platinum electrodes. At the cathode, which is in direct contact with the gas sample to be measured, oxygen molecules are reduced to oxygen ions (O²⁻). The oxygen ions diffuse through a solid electrolyte, for example a ZrO₂ plate, and are oxidized at the anode. The current generated by this oxidation is measured at the amperometer. This necessitates a reference measurement, which is carried using a Pd/PdO solid cell, for example. The effect described here also arises with a potentiometric sensor.

However, not only is oxygen present in the processing area-hydrogen and water are as well. Water is primarily generated from the moisture which is unavoidably contained in the powder. Some metal powders could also contain hydrogen, which can escape during the build process. Oxygen gets into the processing area primarily from points of the processing chamber which are not sealed.

In a first step, water (which escapes from the powder) is split into hydrogen atoms and oxygen atoms by the radiation in the energy beam (for example a laser beam); they recombine to generate molecular oxygen and molecular hydrogen. Hydrogen and oxygen can diffuse in the processing chamber to the sensor; it should be noted here that oxygen is taken up more readily by metal condensates. Thus, it can be assumed that oxygen and hydrogen are not in the processing chamber or at the sensor in a ratio of 1:2. As stated above, the oxygen present in the gas sample in the sensor originates primarily from the locations in the processing area which are not sealed and is not in a chemical relationship with the hydrogen, which is primarily generated from the splitting of water, or escapes directly from the metal powder.

However, water can also be generated from the reaction between oxygen and hydrogen at the sensor. This reaction is caused by the high temperature at the sensor (the operating temperature should be between 300-700° C. in order to enable the oxygen ions to diffuse through the ZrO₂ plate). This reaction leads to a reduction in the measured current at the sensor, because oxygen is consumed in this reaction and therefore no longer reaches the cathode.

In addition to oxygen, hydrogen can be split into hydrogen ions at the sensor and can lead to a current between the electrodes. When the oxygen concentration is significantly higher than the hydrogen concentration, oxygen can be reliably measured by the sensor. In the opposite case (excess of H₂), the hydrogen causes an instability in the sensor. Hydrogen can be adsorbed by platinum in two different states. In one of these states, the absorption of hydrogen brings about an increase in the electrical resistance of platinum; in the other, a reduction in the electrical resistance. The state of the adsorbed hydrogen depends in the first place on the temperature. Because of the high operating temperature of the sensor, hydrogen can change from one state to another and lead to instabilities in the signal.

Furthermore, water (H₂O) can be split into hydrogen anions (H⁺) and hydroxide ions (OH⁻) in the sensor. When at least a minimum concentration of water is present at the sensor (from the build material or from the reaction between hydrogen and oxygen), the water is adsorbed by the platinum. The ions which are generated behave in an analogous manner to oxygen at the sensor: hydrogen anions (H⁺) are reduced at the cathode and hydrogen diffuses into the processing chamber, while hydroxide ions (OH⁻) are oxidized at the anode in a similar manner to oxygen ions. Because of the oxidation of hydroxide ions, a current is measured at the amperometer as if oxygen were present in the processing chamber. This reaction profile is equivalent to the electrolysis of water. The concentration of oxygen is overestimated in this case. Water is consumed in this reaction, and in addition, hydrogen is generated in the processing chamber, which in turn leads to an unstable signal because of the absorption of the hydrogen onto the platinum or in turn to a consumption of oxygen (by the reaction between oxygen and hydrogen), and therefore to a reduction in the signal at the sensor or to an underestimation of the oxygen concentration.

The hydroxide ions may also lead to a current between the electrodes, which would likewise normally be far below the oxygen signal at low oxygen concentrations and high water concentrations, but may also be dominant.

If hydrogen and water are now filtered out of a volume of gas which flows into the sensor module as the gas sample, then the interrupting fractions concerned in the sensor signal would be suppressed or inhibited. In particular, when the filter element is located in the sensor module between the electrodes (in the case of the solid electrolyte), it is advantageous to filter the hydroxide ions out directly.

An apparatus in accordance with the invention (“manufacturing apparatus”) serves for the additive manufacture of a component in a manufacturing process in which build material, preferably comprising a metal powder, on a construction area in a processing area is consolidated by means of irradiation of the build material with at least one energy beam. The apparatus comprises the following components:
a supply device for applying layers of build material to the construction area,
an irradiation device in order to selectively consolidate build material between the application of two layers of material by irradiation with at least one energy beam, as well as
a sensor arrangement in accordance with the invention.

The supply device (for example an arrangement for the layer by layer application of a metal powder) and the irradiation device (for example a laser) are known in the art. The characterizing feature is the sensor arrangement in accordance with the invention, which enables the oxygen concentration to be measured better. In addition to these components, the manufacturing apparatus may have further components, as are usually employed for manufacturing.

It should be pointed out at this juncture that the apparatus in accordance with the invention may also have a plurality of irradiation devices which can be controlled in an appropriately coordinated manner using control data. Only for the sake of completeness is it mentioned here that the energy beam may be both a particle beam as well as an electromagnetic beam such as a beam of light or, as is preferable, a laser beam.

A measurement method in accordance with the invention with a sensor arrangement in accordance with the invention in an apparatus in accordance with the invention comprises the following steps:
producing a flow of gas in the processing area of the apparatus so that a gas sample meets the sensor module by means of the flow of gas,
generating a sensor signal by means of the sensor module of the sensor arrangement,
optionally: using the sensor signal to control or regulate the apparatus.

The gas flow may, for example, be produced by means of a circulating pump or a pump for blowing in a protective or inert gas. In this regard, it does not necessarily have to be blown directly onto the sensor module. It is sufficient for the gas to move by the sensor, which can be brought about by a circulation in the processing area or by means of a flow of air through a line in which the sensor lies.

Control or regulation may be obtained in a simple manner by comparing the sensor signal with a threshold value which represents the threshold between a wanted and an unwanted range. As soon as the sensor signal leaves the unwanted range, then an action is initiated, for example the flow of gas is modified, so that the sensor signal moves back into the wanted range again.

Further particularly advantageous embodiments and developments of the invention will become apparent from the dependent claims as well as from the description below, wherein the independent claims of a category of claims can also apply analogously to the dependent claims and exemplary embodiments of another category of claims and in particular, individual features of different exemplary embodiments or variations may be combined to form novel exemplary embodiments or variations.

In a preferred sensor arrangement, the filter element comprises a molecular sieve and/or an adsorbent through which the gas sample is guided before it permeates into the sensor module. Preferred molecular sieves or adsorbents comprise a zeolite or activated carbon. In particular, zeolite with the correct pore size (3 A) has been shown to be capable of adsorbing hydrogen and water in an advantageous manner. For selectively cleaning hydrogen from working gases, in particular, catalytic adsorption at other suitable adsorbing materials is also possible (molecular sieves, activated carbon, inter alia). As an alternative or in addition, a layer of platinum may be used, by which the gas sample is passed before it permeates into the sensor module. This platinum layer may be present as an extensive surface or in the form of a surface of a granulate.

In accordance with a preferred sensor arrangement, the sensor module has (at least) an anode and (at least) a cathode and in particular is an amperometric or potentiometric sensor. In this regard, preferably, the sensor arrangement comprises a solid electrolyte between the anode and cathode, in particular zirconium dioxide (ZrO₂), and the filter element is disposed in or on the solid electrolyte. In this case, the filter element is therefore located in the sensor module between the electrodes and preferably, it adsorbs hydroxide ions or transforms them into water.

In a preferred sensor arrangement, a filter element is disposed in a manner such that it filters the gas sample before it permeates into the sensor module. This may be an additional filter element to the filter element in the sensor module defined above, or it may be an alternative filter element. Preferably in this regard, the filter element at least partially surrounds the sensor module or at least its electrodes or it is disposed in a manner such that it filters the gas sample in a gas supply to the sensor module (i.e. filters the line to the sensor module).

In accordance with a preferred sensor arrangement, the filter element is formed by an electrode of the sensor module, wherein the electrode material of the electrode is selected such that the conversion of water vapour to hydrogen ions and hydroxide ions and/or the conversion of molecular hydrogen into hydrogen ions and/or the adsorption of water vapour and/or hydrogen is inhibited. Preferably, the electrode material is selected such that because of its chemical properties and/or surface properties, it is capable of adsorbing water and/or hydrogen and in this regard of preventing the water and/or hydrogen from causing an erroneous measurement signal for the oxygen concentration. As an alternative or in addition, the inhibition of the conversion of water and/or hydrogen into ions may be given by the chemical properties and/or the surface properties of the electrode material. The adsorption of water and hydrogen and/or the inhibition of an erroneous measurement signal and/or the inhibition of the conversion of water and/or hydrogen into ions may be obtained and/or reinforced by the modification of the voltage applied to the electrodes during the measurement operation and/or by a modification of the operating temperature of the sensor module.

A preferred sensor arrangement comprises a controller which is configured to control the operating voltage and/or operating temperature of the sensor module and/or the operating temperature of the filter element. In this regard, the voltage or temperature is kept within a predetermined range in which an ionisation, accumulation or deposition of water vapour and/or hydrogen is prevented. A voltage here is preferably decreased below a predetermined threshold value. Preferably in this regard, the operating voltage of the sensor is decreased by ±0.8/0.9V to ±0.3/0.4V. It is generally preferable to operate the sensor at a temperature between 300-700° C.

Preferably, the filter element comprises a temperature controller with which the filter element can be heated and/or cooled. Heating may in particular be carried out when a manufacturing process is not being carried out, in order to relinquish adsorbed substances and therefore to clean the filter element. Cooling may be employed in order to adjust an adsorption rate. Preferably, the controller is configured to control or regulate this temperature control of the filter element as a function of the sensor signal.

A preferred sensor arrangement comprises a reference sensor module (wherein this term, as mentioned above, may also mean a sensor with a reference component) which is preferably operated at a different voltage than the sensor module, in particular at a lower voltage. As an alternative or in addition, the reference sensor module comprises a reference gas in a reference chamber as the gas sample (preferably in the case of a potentiometric sensor module). As an alternative or in addition, the reference sensor module comprises a reference measurement cell, preferably a solid cell, for example produced from palladium/palladium oxide. This embodiment preferably concerns an amperometric sensor module. As an alternative or in addition, the reference sensor module is disposed in a manner such that the gas sample permeating into the reference sensor module is not filtered by the filter element. As an alternative or in addition, the reference sensor module comprises a reference filter element which differs from the filter element in its material and/or its construction, which filters the gas sample which permeates into the sensor module.

A preferred apparatus comprises a gas pump. This should be understood to mean an element with which a pressure can be applied to a gas or with which a gas can be moved. The gas can be moved much better through the filter element to the sensor module under pressure, because the filter element sets up a resistance to the flow of gas. As the gas flows through the filter element, then, every component which could falsify the measurement signal is filtered out. A pressure difference may, for example, be produced by the filter system of an inert gas circuit. The apparatus is preferably configured in a manner such that a gas sample is moved to the sensor arrangement by means of the gas pump, preferably wherein the gas pump is configured in a manner such that the volume of gas in a processing area of the apparatus is circulated, a volume of gas is discharged from the processing area or a gas, in particular an inert gas, is introduced into the processing area.

A preferred apparatus comprises a conduit. The sensor module of the sensor arrangement is disposed in this conduit in a manner such that a gas flowing through the conduit serves as the gas sample for a measurement. Preferably, the filter element is disposed in the conduit in a manner such that the gas flowing through the conduit is filtered before it meets the sensor module.

A preferred apparatus comprises an air circulation system which is connected to the processing chamber by conduits. The air circulation system may comprise a gas pump which may be operated in a manner such that a volume of gas can be discharged from the processing chamber and an inert gas can be introduced into the processing chamber. Inlet and/or outlet valves may be disposed at the inlet and/or outlet of the conduit which connects the air circulation system to the processing chamber, which can carry out and/or facilitate the discharge and/or supply of gas. Optionally, the air circulation system comprises a filter unit (which should not be confused with the filter element of the sensor arrangement) which can clean the volume of gas removed from the processing chamber. In a preferred embodiment, the sensor arrangement is located in a conduit which connects the air circulation system to the processing chamber and the filter element is disposed in the conduit in a manner such that the gas flowing through the conduit is filtered before it meets the sensor module. As an alternative, the sensor arrangement is located in the vicinity of the inlet and/or the outlet of a conduit.

In a preferred measurement method, the gas flow is controlled on the basis of the sensor signal. In particular, the gas flow here is increased when the sensor signal exceeds a predefined threshold or drops below a predefined threshold. As an alternative or in addition, the build process of the apparatus is preferably carried out independently of the sensor signal. As an example, if the oxygen concentration is too high, the manufacturing process is interrupted for at least a predetermined time.

In a preferred measurement method, for a reference measurement, the partial pressure of oxygen in the sensor module is reduced to a predetermined minimum concentration. This is preferably carried out by pumping with a voltage or by an oxygen adsorbent or by specific flushing of the sample gas. Pumping with a voltage may be carried out by applying a voltage to the (platinum) electrodes of the sensor module which, for example, may be higher than the operating voltage for the measurement of the oxygen concentration, whereupon this functions as an oxygen pump (by ionisation and motion in an electrical field). In this regard, oxygen is guided from the atmosphere to be measured through the electrolytes. As an alternative or in addition, the voltage applied to the electrodes may be reversed compared with the operating voltage, so that the oxygen content in the reference sensor module is reduced.

In a preferred embodiment, the sensor arrangement comprises a motion device by means of which the filter element can be moved from a rest position into a filtering position, for example in front of the sensor module (and back). This is preferably carried out on the basis of the sensor signal. Preferably in this case, in which it can be deduced from the sensor signal that the sensor is measuring outside a desired range, the filter element is moved into the filtering position, for example in front of the sensor element. In this respect, the preferred case is also that in which various filter elements are present which can be moved into the filtering position as a function of a state deduced from the sensor signal.

Preferably also, a plurality of sensors are present which have different filter elements.

The invention will now be described again in more detail with reference to the accompanying figures and with the aid of exemplary embodiments. In this regard, in the various figures, identical components are provided with the same reference symbols. In the figures:

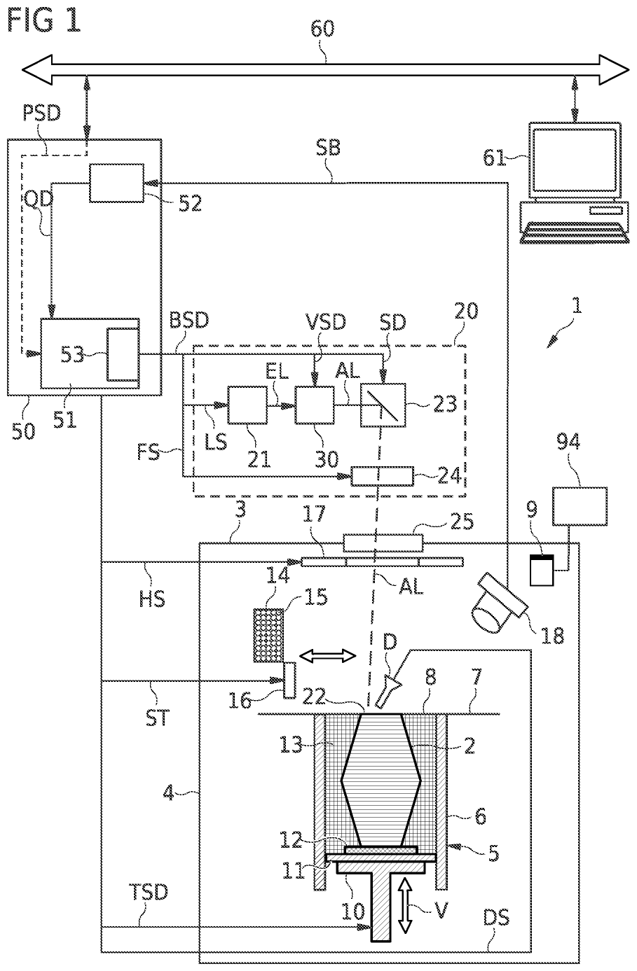

FIG. 1 shows a diagrammatic, partially sectional view of an exemplary embodiment of an apparatus for additive manufacture with a sensor arrangement in accordance with the invention,

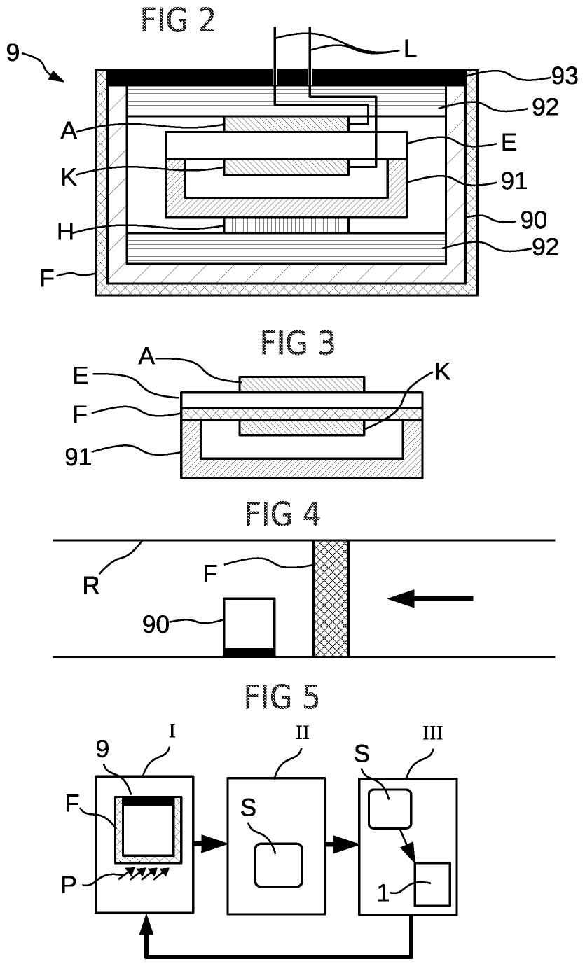

FIG. 2 shows an example of a sensor arrangement in accordance with the invention with a surrounding filter element,

FIG. 3 shows an example of a sensor arrangement in accordance with the invention with a built-in filter element,

FIG. 4 shows a further example of a sensor arrangement in accordance with the invention in a conduit,

FIG. 5 shows a block diagram of possible steps of the procedure in a preferred measurement method.

The exemplary embodiments below are described with reference to an apparatus 1 for the additive manufacture of components in the form of a laser sintering or laser melting apparatus 1, wherein it is explicitly stated once again that the invention is not limited to laser sintering or laser melting apparatuses. The designation of the apparatus is therefore abbreviated below to a “laser sintering apparatus” 1 without any limitation to the generality.

A laser sintering apparatus 1 is shown diagrammatically in FIG. 1. The apparatus has a processing chamber 3 or a processing area 3 with a chamber wall 4 in which the manufacturing process is substantially carried out. In the processing chamber 3 is a container 5 which is open to the top and which has a container wall 6. The upper opening of the container 5 forms the respectively current working plane 7. The region of this working plane 7 which lies inside the opening of the container 5 can be used for the construction of the object 2 and is therefore designated as the construction area 8.

The container 5 has a base plate 11 which can be moved in a vertical direction, which is disposed on a carrier 10. This base plate 11 closes the container 5 from below and therefore forms its bottom. The base plate 11 may be formed integrally with the carrier 10, but it may also be separate from the plate forming the carrier 10 and be attached to the carrier 10 or simply mounted on it. Depending on the specific type of the build material, i.e. the powder used and the manufacturing process, for example, a construction platform 12 may be attached to the base plate 11 as a construction substrate, on which the object 2 is constructed. In principle, however, the object 2 may also be constructed on the base plate 11 itself, which then forms the construction substrate.

The basic construction of the object 2 is carried out by initially applying a layer of build material 13 to the construction platform 12, then selectively consolidating the build material 13 with a laser beam AL as the energy beam at points which are to form parts of the object 2 to be manufactured, then the base plate 11, and therefore the construction platform 12, is lowered with the aid of the carrier 10 and a new layer of the build material 13 is applied and selectively consolidated, and so on. FIG. 1 shows the object 2 constructed in the container in an intermediate state on the construction platform 12 below the working plane 7. It already has a plurality of consolidated layers, surrounded by build material 13 which has remained non-consolidated. A variety of materials may be used as the build material 13, preferably powders, in particular metal powders, plastic powders, ceramic powders, sand, filled or mixed powders, and also pasty materials. The invention is of particularly advantageous application to metallic build materials 13.

Fresh build material 15 is located in a reservoir 14 of the laser sintering apparatus 1. The build material can be applied to the working plane 7 or inside the construction area 8 in the form of a thin layer with the aid of a coater 16 which can be moved in a horizontal direction (double-headed arrow).

Optionally, an additional radiant heater 17 is located in the processing chamber 3. This may serve to heat the applied build material 13 so that the irradiation device used for the selective consolidation does not have to introduce too much energy. This means that, for example with the aid of the radiant heater 17, a basic quantity of energy has already been introduced into the build material 13, which naturally is still below the energy necessary for the build material 13 to melt or in fact sinter. An example of a radiant heater 17 is an infrared emitter.

For the selective consolidation, the laser sintering apparatus 1 has an irradiation device 20, or specifically an illumination device 20, with a laser 21. This laser 21 produces a laser beam EL which is initially supplied to a beam formation device 30 (as the input energy beam EL or input laser beam EL). As has already been described above, the beam formation device 30 may then be used in order to modify the intensity distribution, i.e. the profile of the intensity of the energy beam, in order to overlay a top hat profile on top of a Gaussian profile. To this end, the beam formation device 30 may be controlled with suitable intensity distribution control data, VSD.

A preferred beam formation device 30 here may, for example on the inlet side, have a beam divider in the form of a thin layer polarizer which divides the incoming laser beam EL into two linearly polarised part-beams. Each of these linearly polarised part-beams can be guided to a separate beam formation element. These beam formation elements are responsible for the actual formation of the beam. In this regard, it may, for example, be what is known as a passive DOE (DOE=Diffractive Optical Element) which operates by reflection and modifies the wave front of the incident part-beam through local modulation of the phase and/or amplitude. An example of this is a LCoS Micro-Display (LCoS=Liquid Crystal on Silicon), which can be controlled with the appropriate intensity distribution control data, VSD, which can be delivered from the beam control interface 53 of the control device 50 of the laser sintering apparatus 1 which will be described below.

The (output) energy beam or laser beam AL, optionally modified by the beam formation device, is then deflected via a downstream deflection device 23 (scanner 23) in order thereby to traverse the consolidation pathways (i.e. the illumination pathways or tracks) provided in accordance with the illumination strategy in the respective layer to be consolidated and to selectively introduce the energy. This means that by means of the scanner 23, the impact surface 22 of the energy beam AL is moved on the construction area 8, whereupon the current movement vector or the direction of movement (scanning direction) of the impact surface 22 on the construction area 8 can be modified frequently and rapidly. In this regard, this laser beam AL is focused through a focusing device 24 onto the working plane 7 in a suitable manner. The irradiation device 20 here is preferably located outside the processing area 3 and the laser beam AL is guided into the processing area 3 via a coupling window 25 in the chamber wall 4 attached to the top of the processing area 3.

The irradiation device 20 may comprise not just one but a plurality of lasers, for example. Advantageously in this regard, it may be a gas or solid state laser or any other type of laser, such as laser diodes, for example, in particular VCSEL (Vertical Cavity Surface Emitting Laser) or VECSEL (Vertical External Cavity Surface Emitting Laser), or a line of these lasers. More particularly preferably, in the context of the invention, one or more unpolarised single mode lasers, for example a 3 kW fibre laser with a wavelength of 1070 nm, may be employed.

In the exemplary embodiment shown, an optional, preferably displaceable and/or movable nozzle D is disposed in the processing chamber 3 which can be used to supply a gas or a mixture of gases into the region of the impact surface of the laser beam AL on the construction area 8 in order to influence the nominal weld depth in this manner.

Furthermore, the laser sintering apparatus 1 contains a detector assembly 18 which is suitable for detecting a process beam emitted during the impact of the laser beam AL on the build material in the working plane. This detector assembly 18 operates with spatial resolution, i.e. it is capable of detecting a kind of emission image of the respective layer. Preferably, an image sensor or a camera 18 which is sufficiently sensitive in the range of the emitted radiation is used as the detector assembly 18. As an alternative or in addition, one or more sensors for detecting an optical and/or thermal process beam could be used, for example photodiodes, which detect the electromagnetic radiation emitted from a meltpool under the impact of the laser beam AL, or temperature sensors for detecting an emitted thermal radiation (what is known as meltpool monitoring). An association of the signal from a non-spatially resolved sensor with the coordinates would be possible, wherein the coordinates which are used to control the laser beam are temporally associated with the respective sensor signal. In FIG. 1, the detector assembly 18 is shown inside the processing chamber 3. However, it could also be located outside the processing chamber 3 and the process beam would then be detected through a further window in the processing chamber 3.

The signals detected by the detector assembly 18 may be transferred here as a processing area sensor data set or slice image SB to a control device 50 of the laser sintering apparatus 1 which also serves to place the various components of the laser sintering apparatus 1 under the overall control of the additive manufacturing process.

To this end, the control device 50 comprises a control unit 51 which controls the components of the irradiation device 20 via an irradiation control interface 53, namely in this case sends laser control data LS to the laser 21, sends intensity distribution control data VSD to the beam formation device 30, sends scan control data SD to the deflection device 23 and sends focus control data FS to the focusing device 24. The totality of these data may be designated as illumination control data, BSD.

The control unit 51 also controls the radiant heater 17 by means of suitable heating control data HS, controls the coater 16 by means of coating control data ST and controls the movement of the carrier 10 by means of carrier control data TSD, and therefore controls the layer thickness. Furthermore, it also controls the nozzle D with the aid of nozzle control data DS.

In addition, the control device 50 here has a data quality determination device 52 which contains the processing area sensor data set SB and determines the data quality based on it which can, for example, be transmitted to the control unit 51 in order to be able to engage with the additive manufacturing process for control purposes.

The control device 50 is coupled to a terminal 61 with a display or the like, for example in this case via a bus 60 or another data connection. Via this terminal, an operator can control the control device 50 and therefore the entire laser sintering apparatus 1, for example by transmitting process control data PSD.

In the processing area 3, a sensor arrangement 9 in accordance with the invention is disposed in the upper right hand corner in this example which measures the oxygen concentration in the processing area. As discussed above, the oxygen concentration in the processing area 3 can rise because of leaks in the supply of gas to the processing area 3 or because of splitting of moisture in the build material 13 by the energy beam AL, or it can fluctuate due to the supply of protective gas. The construction of this sensor arrangement 9 will be described in more detail below.

In this example, the sensor arrangement 9 comprises a controller 94 which is configured to control the operating voltage and/or operating temperature of the sensor module 90 and/or the operating temperature of the filter element F, so that there, an ionisation, accumulation or deposition of water vapour is avoided.

FIG. 2 shows an example of a sensor arrangement 9 in accordance with the invention with a surrounding filter element F as can be used for an apparatus 1 in accordance with FIG. 1. The outside of the sensor arrangement 9 comprises a gas-permeable sensor housing 90 (which is shown here also with the components contained in the sensor module 90), which is covered by a cover 93. The sensor arrangement 9 can be attached to the chamber wall 4 of the processing chamber 3 by means of this cover 93. Lines L for the sensor module 90 can be fed out through a hole in the chamber wall 3. It is also possible, however, for the cover 93 to be somewhat longer and provided with a screw thread so that the sensor module can be passed from outside through a hole in the chamber wall 4 and can be screwed in there.

In this example, the sensor module 90 (or the sensor housing 90) is surrounded on all sides by the filter element F up to the cover 93, so that gas which enters into the sensor module 90 as the gas sample P (see FIG. 5) is filtered. The filter element F here is selective and here it filters out only water vapour. It can additionally also filter out hydrogen.

The functional components of the sensor module 90 are disposed inside the sensor housing 90. They are the anode A and the cathode K, which are separated by a solid electrolyte E, for example zirconium dioxide, and the heater H for heating the inner chamber 91, in which the cathode K is disposed. This functional construction corresponds to the prior art and is retained by two fixing elements 92, for example glass wool. The voltages or currents at the electrodes A, K are conveyed out by means of the lines L where they can be processed further. The heater H also has two lines for supplying energy, but are not shown for the sake of clarity.

Although the filter element F surrounds the entire sensor arrangement in FIG. 2, it may also surround only a portion of the sensor module.

Although the filter element F in FIG. 2 is in direct contact with the sensor module, 90, it may also be in at least partial contact with the sensor module 90. The filter element F and the sensor module 90 may also not be in contact. The filter element F may also be sufficiently close to the sensor module 90 so that by the action of the filter element, the concentration of gas components which could falsify the signal from the sensor module 90 is kept sufficiently small.

FIG. 3 shows an example of a sensor arrangement 9 in accordance with the invention with a built-in filter element F. Only the functional construction with the inner chamber 91, anode A, solid electrolyte E and cathode K are shown here. The filter element F here is disposed on the solid electrolyte E and preferably filters out hydroxide ions.

FIG. 4 shows a further example of a sensor arrangement in accordance with the invention in a conduit R. The sensor module 90 (the sensor arrangement 9 from FIG. 2 without the surrounding filter element F) shown in FIG. 2 may be considered to be the sensor module 90. The filter element F here is disposed in the conduit R and gas which flows through the conduit R (arrow) must first pass the filter element F before it meets the sensor module 90. In one embodiment, the conduit R is connected to a gas pump. A gas can be pressurized through the conduit R with the aid of the gas pump or gas can be moved through the conduit R. The gas can be moved through the filter element F to the sensor module 90 much better under pressure, because the filter element F sets up a resistance to the flow of gas. When the gas flows through the filter element F, all of the components which could falsify the measurement signal are filtered out. The gas pump to which the conduit R is connected can accordingly be configured to circulate a volume of gas in a processing area of the apparatus, to discharge a volume of gas out of the processing area through the conduit R or to introduce a gas, in particular an inert gas, through the conduit R into the processing area. Preferably, the filter element F and the sensor module 90 are disposed in the conduit R, wherein a volume of gas is removed from the processing area through the conduit R with the aid of the gas pump. In this regard, the sensor module 90 and the filter element F are disposed in a manner such that the volume of gas which is discharged initially impinges upon the filter element and then permeates into the sensor module. When the gas flows through the filter element F, then all of the components which could falsify the measurement signal are filtered out.

In a further embodiment, the conduit R connects the processing chamber to an air circulation system. The air circulation system, to which the conduit R is connected, can, preferably with the aid of a gas pump, be configured to remove a volume of gas from the processing area through the conduit R or to introduce a gas, in particular an inert gas, through the conduit R into the processing area. Preferably, the filter element F and the sensor module 90 are disposed in the conduit R, wherein a volume of gas is discharged from the processing area through the conduit R. In this regard, the sensor module 90 and the filter element F are disposed in a manner such that the removed volume of gas initially impinges on the filter element and then permeates into the sensor module. When the gas flows through the filter element F, then all of the components which could falsify the measurement signal are filtered out.

FIG. 5 shows a block diagram of possible steps of the procedure for a preferred measurement method with a sensor arrangement 9 as shown in the preceding figures, for example, in an apparatus 1 as shown in FIG. 1, for example.

In step I, a flow of gas is produced in the processing area 3 of the apparatus 1 so that a gas sample P meets the sensor module 90 via the flow of gas.

In step II, a sensor signal S is generated by the sensor module 90 of the sensor arrangement 9.

In step III, the sensor signal S for controlling or regulating the apparatus 1 is used, wherein, for example, a flow of gas in the processing chamber 3 is controlled on the basis of the sensor signal S, so that the flow of gas is increased when the sensor signal exceeds a predefined threshold.

In this regard, the method is consistently repeated, as indicated by a feedback arrow.

Finally, it should be indicated once again that the apparatuses described in detail above relate only to exemplary embodiments which could be modified by the person skilled in the art in very different manners without departing from the scope of the invention. Furthermore, the use of the indefinite article “a” or “an” does not exclude the fact that the features in question could also be present in a plurality thereof. Similarly, the term “unit” does not exclude the fact that this could consist of a plurality of cooperating secondary components which could optionally also be distributed in space.

### LIST OF REFERENCE SYMBOLS

1 apparatus for additive manufacture/laser sintering apparatus
2 component/object
3 processing area/processing chamber
4 chamber wall
5 container
6 container wall
7 working plane
8 construction area
9 sensor arrangement
10 carrier
11 base plate
12 build platform
13 build material (in container 5)
14 reservoir
15 build material (in reservoir 14)
16 coater
17 radiant heater
18 sensor arrangement/camera
20 irradiation device/illumination device
21 laser
22 impact surface (of laser beam)
23 deflection device/scanner
24 focusing device
25 coupling window
30 beam formation device
50 control device
51 control unit
52 data quality determination device
53 irradiation control interface
60 bus
61 terminal
90 sensor module/sensor housing
91 inner chamber
92 fixing element
93 cover
94 controller
A anode
AL (output) energy beam/laser beam
BSD control data/illumination control data
D nozzle
DS nozzle control data
E solid electrolyte
EL input energy beam/laser beam
F filter element
FS focusing control data
H heating
HS heating control data
K cathode
LS laser control data
P gas sample
PSD process control data
QD quality data
R conduit
S sensor signal
SB processing area sensor data set/slice image
SD scan control data
SI layer information
SM hatched segment/strips
ST coating control data
TSD carrier control data
VSD intensity distribution control data

1. A sensor arrangement for an apparatus for the additive manufacture of a component in a manufacturing process in which build material is consolidated on a construction area in a processing area by means of irradiation of the build material with at least one energy beam, the sensor arrangement comprising:
a sensor module which is configured to detect oxygen molecules in a gas sample permeating into the sensor module and to generate an electrical sensor signal based on the quantity of the oxygen molecules,
a selective filter element configured to filter the gas sample so that at least hydrogen molecules and/or hydrogen ions and/or water molecules and/or hydroxide ions are filtered out of the gas sample.

2. The sensor arrangement of claim 1, wherein the filter element comprises a zeolite or activated carbon, through which the gas sample is guided before it permeates into the sensor module, or a layer of platinum by which the gas sample is passed before it permeates into the sensor module.

3. The sensor arrangement of claim 1, wherein the sensor module has an anode and a cathode and is an amperometric or potentiometric sensor,
wherein the sensor arrangement comprises zirconium dioxide between the anode and cathode, and the filter element is disposed in or on the solid electrolyte.

4. The sensor arrangement of claim 1, wherein a filter element is disposed in a manner such that it filters the gas sample before it permeates into the sensor module and at least partially surrounds the sensor module or at least its electrodes or is disposed in a manner such that it filters the gas sample in a gas supply to the sensor module.

5. The sensor arrangement of claim 1, wherein the filter element is formed by an electrode of the sensor module, wherein the electrode material of the electrode is selected such that the conversion of water vapour to hydrogen ions and hydroxide and/or the conversion of molecular hydrogen into hydrogen ions and/or the adsorption of water vapour and/or the adsorption of hydrogen is inhibited.

6. The sensor arrangement of claim 1, comprising a controller which is configured to control the operating voltage and/or operating temperature of the sensor module and/or the operating temperature of the filter element in a manner such that an ionisation, accumulation or deposition of water vapour is prevented, wherein the voltage is decreased below a predetermined threshold value.

7. The sensor arrangement of claim 1, comprising a reference sensor module which
is operated at a different voltage to that of the sensor module, and/or
comprises a reference gas in a reference chamber as the gas sample, and/or
comprises a palladium/palladium oxide solid cell, and/or
has different electrodes than the sensor module, and/or
is disposed in a manner such that the gas sample permeating into the reference sensor module is not filtered through the filter element, and/or
comprises a reference filter element which differs from the filter element in its material and/or its construction, which filters the gas sample which permeates into the sensor module.

8. An apparatus for the additive manufacture of a component in a manufacturing process in which build material on a construction area in a processing area is consolidated by means of irradiation of the build material with at least one energy beam, the apparatus comprising:
a supply device for applying layers of build material to the construction area,
an irradiation device in order to selectively consolidate build material between the application of two layers of material by irradiation with at least one energy beam, as well as
a sensor arrangement as claimed in claim 1.

9. The apparatus of claim 8, comprising a gas pump, wherein the apparatus is configured in a manner such that a gas sample is moved to the sensor arrangement by means of the gas pump, wherein the gas pump is configured in a manner such that the volume of gas in a processing area of the apparatus is circulated, a volume of gas is discharged from the processing area, or an inert gas is introduced into the processing area.

10. The apparatus of claim 8, comprising a conduit, wherein the sensor module of the sensor arrangement is disposed in the conduit in a manner such that gas flowing through the conduit serves as the gas sample for a measurement, wherein the filter element is disposed in the conduit in a manner such that the gas flowing through the conduit is filtered before it meets the sensor module.

11. A measurement method with a sensor arrangement of claim 1, comprising the steps of:
producing a flow of gas in the processing area of the apparatus so that a gas sample meets the sensor module by means of the flow of gas,
generating a sensor signal by means of the sensor module of the sensor arrangement,
using the sensor signal to control or regulate the apparatus.

12. The measurement method of claim 11, wherein the manufacturing process and/or the gas flow is controlled on the basis of the sensor signal, wherein the gas flow is increased when the sensor signal exceeds a predefined threshold or drops below a predefined threshold, and/or wherein the build process of the apparatus is carried out independently of the sensor signal (S).

13. The measurement method of claim 11 wherein, for a reference measurement, the partial pressure of oxygen in the sensor module is reduced to a predetermined minimum concentration, by pumping with a voltage or an oxygen adsorbent or by specific flushing of the sample gas.

14. The measurement method of claim 11, wherein the filter element comprises a temperature controller with which the filter element can be heated and/or cooled, wherein this temperature controller is controlled or regulated as a function of the sensor signal.

15. The measurement method of claim 11, wherein the sensor arrangement comprises a motion device by means of which the filter element can be moved from a rest position into a filtering position, wherein this motion is carried out on the basis of the sensor signal, in the case in which it can be deduced from the sensor signal that the sensor is measuring outside a desired range, wherein various filter elements are present which can be moved into the filtering position as a function of a state deduced from the sensor signal.
